(19) United States
(12) Patent Application Publication
(10) Pub. No.: US 2002/0161684 A1
(43) Pub. Date: Oct. 31, 2002

(54) Method of creating new securities from equities: separately tradable registered independent dividend and equity securities ("STRIDES")

(76) Inventor: Brian L. Whitworth, Malibu, CA (US)

Correspondence Address: Brian L. Whitworth, 3003 Sequit Dr., Malibu, CA, 90265, US

(21) Appl. No.: 09/844,972

(22) Filed: Apr. 27, 2001

(51) Int. Cl. G06F 17/60

(52) U.S. Cl. 705/36

(57) ABSTRACT

Methods are disclosed for creating new types of securities, including equity dividend strips, equity dividend strip futures, equity dividend strip options, new index fund stocks, new mutual fund investments, and related securities are created in consideration of the cash dividends paid by companies issuing the original stock. Similar financial products are created for nondividend paying stock.

Additionally, the principles of the present invention can be employed to provide new corporate financing methods which make use of the aforementioned securities. An example of such a new method is the issuance of original common stock with a detachable dividend strip.

Purchase both and put the dividend strip into your retirement account.

Purchase both and donate the dividend strip to charity.

Give the dividend strip to a minor child, or a child in college.

The stock does not need to be paying dividends at the time the dividend strip is created. The dividend strip covers all future dividends, even if there are none now.

Investors can set dividend policy themselves, as long at the constraint is met: total dividends paid by company=total dividend received by security holders. Many security holders will have only stripped stock, or only stripped dividend.

### BACKGROUND OF THE INVENTION

1. Field of the Invention

The present invention relates to methods of creating new securities from common stock. The new securities separate dividend payments from stock appreciation or depreciation and allow separate ownership and trading of each.

2. Description of the Related Art

Common Stock

A number of different methods of investing in common stock currently exist. Individual stocks may yield substantial dividends, small dividends or no dividends at all. Dividends potentially produce a number of problems for individual and institutional investors.

For most investors, cash dividends are currently taxed as ordinary income when the dividend is received. By contrast, any profit from the appreciation of stock is not taxed until the stock is sold. Profits from the sale are usually taxed at a lower rate than dividends.

Paying dividends to large numbers of stockholders is an involved task for many publicly held companies. Some companies have millions of shareholders who receive quarterly checks. Particularly for individual investors, many of these checks are small, often under $20 per quarter, and can become a nuisance. Many companies allow shareholders to elect “dividend reinvestment”, where dividends for that shareholder are not paid in cash, but are used to purchase small amounts of additional stock. In the case where a shareholder elects dividend reinvestment, taxation and tax accounting are similar to receiving dividends in cash. Many investors receive dividends in cash and make donations to not-for-profit organizations. Though contributions to not-for-profits can offset taxes on dividend income, a typical process is: 1) investor receives a dividend check, 2) deposits that check, 3) investor writes another check to a charity or other not-for-profit, 4) receives receipt from not-for profit, 5) receives tax forms from company which paid dividends, 6) fills in tax forms with relevant information.

An oddity of tax policy in the U.S. is that the same investor may make very different investment decisions on tax exempt or tax deferred retirement accounts than taxable investment accounts due to the different tax treatment of dividends. For example, an investor might have a portfolio in their retirement account with a higher dividend yield than in their taxable account.

Mutual funds and pension funds receive large amounts of dividends quarterly and often will immediately reinvest the proceeds. In some cases, the mutual fund or pension fund would prefer not to have the administrative burden of reinvestment.

Index Funds

A number of funds attempt to track the performance of a particular group of stocks, such as utility stocks, stocks in the S&P 500, or stocks in the Nasdaq 100 Index. Among these funds are unit investment trusts and mutual funds. An example of a tracking mutual fund is the Vanguard 500 Fund, which attempts to mirror the S&P 500 index. A similar unit investment trust which is traded on exchanges in the same manner as stock in an individual company, is the SPDR (traded on the American Exchange, symbol SPY). A prospectus for the SPDR investment is incorporated by reference.

Index funds consolidate dividends from stocks owned by the fund and pay the appropriate amount to each of the funds' investors. While there are far fewer dividend checks than if fund investors owned individual stocks directly, the investor will still need to decide on whether to reinvest the dividends and will still have to pay applicable taxes on the dividends when received.

Treasury Strips

U.S. Treasury strips have been available since 1985. These strips separate a Treasury bond into multiple securities, one for each principal or interest payment. Thus, a 10-year Treasury can be stripped with 21 resulting securities (1 principal payment and 20 interest payments, one every 6 months for the 10 year term). Each of the resulting stripped securities can be traded separately, much like a zero-coupon bond.

While stock dividends have some similarities to interest payments on bonds and stock prices have a lesser similarity to bond principal, the mechanism for creating STRIDES described herein typically creates only one new security for all future dividend payments and a separate security which is a nondividend paying stock. Of course, STRIDES apply to a large and diverse group of equities with various risk profiles, whereas Treasury STRIPS apply to fixed income securities from a single issuer, the U.S. Government.

Primes and Scores

During the 1980s a collection of securities known as Primes and Scores were traded in the U.S. These securities split common stock shares for individual companies into two components—the Prime, which allowed investors to reap dividends but limited capital gains up to the “termination claim,” and the Score, which gave holders the ability to profit from capital gains above the termination claim level. The products traded on the American Stock Exchange, until the Internal Revenue Service removed the tax advantages of setting up the trust products, thus killing them off. By 1992, all the trusts had expired; no additional ones have since been created. Primes and Scores were not traded on indexes, but only on individual stocks.

Presently, there are no known exchange-traded securities which allow an investor to separate ownership of a dividend-paying stock into components which allow the dividends to be separately owned and traded. Similarly, there are no known exchange-traded securities which allow an investor to separate ownership of an index or mutual fund of multiple stocks into components which allow the dividends of stocks in such index or fund to be separately owned or traded.

In view of the foregoing, there is clearly a need for a method of creating securities which allow separate ownership of dividend streams from individual stocks or stock index funds.

Accordingly, it is an object of the present invention to provide methods for allowing investors to separately purchase, trade, or sell dividend streams of a single stock.

It is another object of the present invention to provide methods for allowing investors to separately purchase, trade, or sell dividend streams of multiple stocks in an index or mutual fund.

It is another object to provide substantial additional flexibility and investment options for individuals and institutions.

It is another object to facilitate and simplify charitable contributions and related tax treatment.

It is another object to allow the creation of new financial and investment products which are made possible by STRIDES.

It is another object provide an opportunity for market forces to value stock appreciation and dividends separately.

It is another object to provide a method for reducing administrative burdens for investors who prefer not to receive dividends.

It is another object to provide methods of trading options and futures on new securities created by STRIDES.

It is another object to allow creation of index shares which track an index of stocks minus ordinary dividends.

### SUMMARY OF THE INVENTION

An exemplary preferred method according to the present invention includes one or more of the following steps: taking one or more stocks, stock indexes, or mutual funds; creating exchange-traded securities which allow the separation or stripping of ordinary dividends; creating original issue stock which can be separated into a tradable dividend security and an nondividend-paying security; and creating related futures and options.

According to an exemplary preferred method of the present invention, equity dividend strips, equity dividend strip futures, equity dividend strip options, new index fund stocks, new mutual fund investments, and related securities are created in consideration of the cash dividends paid by companies issuing the original stock. Similar financial products are created for nondividend paying stock.

Additionally, the principles of the present invention can be employed to provide new corporate financing methods which make use of the aforementioned securities. An example of such a new method is the issuance of original common stock with a detachable dividend strip.

### DESCRIPTION OF THE DRAWINGS

Other objects, features and advantages of the invention will become readily apparent upon reference to the following detailed description when considered in conjunction with the accompanying drawings, in which like reference numerals designate like parts throughout the figures thereof, and wherein:

FIG. 1 is a high level, functional flowchart embodying an exemplary preferred system and method according to the present invention.

FIG. 2 is a flowchart showing steps involved in creating an equity dividend strip and a nondividend-paying security for a single stock.

FIG. 3 is a flowchart showing steps involved in creating an equity dividend strip and a nondividend-paying security for or an index of multiple stocks.

FIG. 4 is a flowchart shows steps involved in creating a standalone equity dividend strip future or option for a single stock or an index of multiple stocks.

FIG. 5 is a flowchart showing how a company can issue its own common stock with a detachable dividend strip.

### DETAILED DESCRIPTION OF THE PREFERRED EMBODIMENTS

An exemplary preferred embodiment of the present invention is adapted to create equity dividend strips and nondividend paying stock.

Major Inputs and Outputs

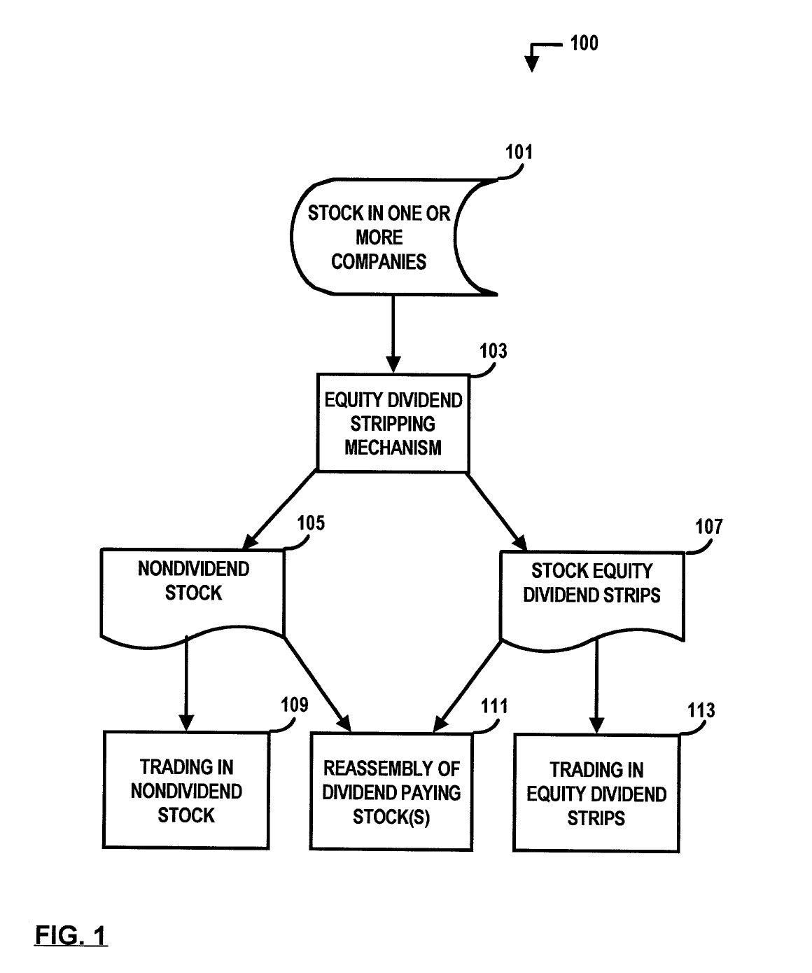

Referring to FIG. 1, an exemplary preferred system 100 according to the present invention uses stock in one or more companies 101 and an equity dividend stripping mechanism 103, to create nondividend yielding stock 105 and stock equity dividend strips 107. Once issued, nondividend yielding stock 105 and stock equity dividend strips 107 can be owned and traded separately, or can be recombined into a dividend-paying stock. Thus, trading in nondividend stock 109 and equity strips 113 may occur separately, or the nondividend stock 109 and matching equity strips 113 may be reassembled into dividend-paying stock 111.

Most mechanisms available for owning or trading shares in a company, an index fund, or a mutual fund are theoretically available for trading nondividend stock 105 and stock equity dividend strips 107. Such ownership and transfer mechanisms include, but are not limited to: transfer on an organized exchange, transfer over the counter, and private transactions with no publicly available record of the transactions.

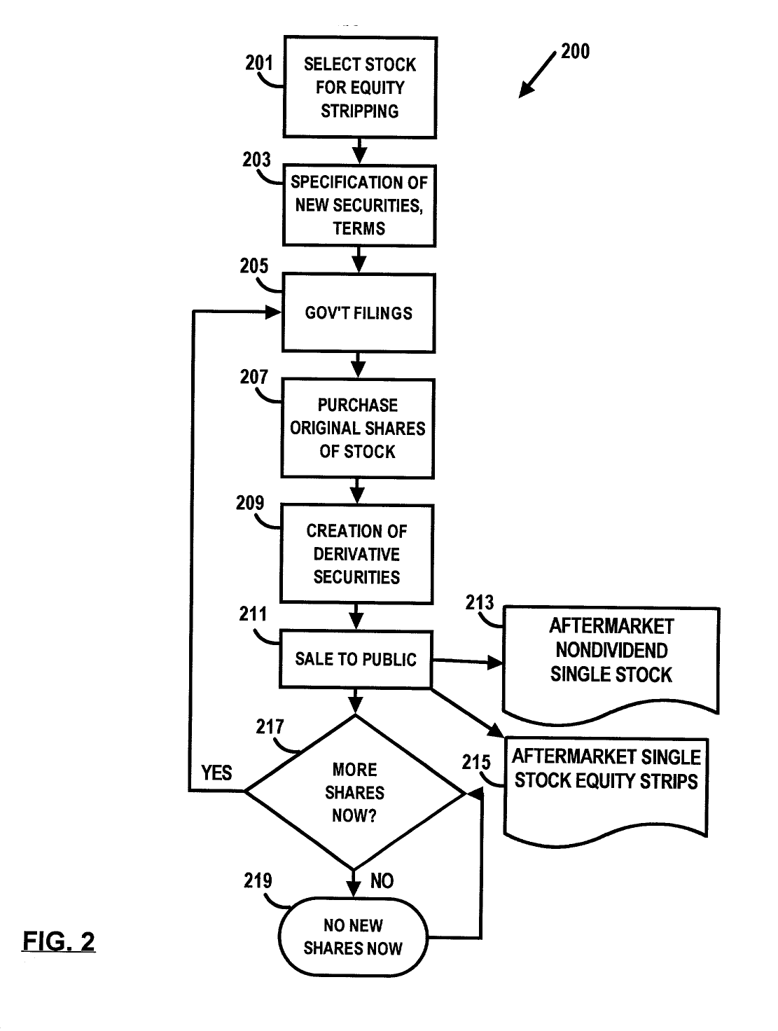

Multiple equity dividend stripping mechanisms 103, are described in FIGS. 2 through 5.

Equity Strips for an Existing Stock In a Single Company

FIG. 2 illustrates steps of an exemplary preferred method 200 for creating equity dividend strips using existing shares of a single company.

At step 201, a stock is selected for equity stripping. There are a large number of possible methods for selecting such a stock. Such methods might include: a request from the company whose outstanding stock will be stripped; choosing a company with a large number of outstanding shares and a high dividend yield; performing surveys or market research among potential investors; financial ratio analysis; choosing a company which currently does not pay dividends, but may do so in the future; or searching for a company with a high number of dividend checks issued each quarter.

At step 203, the new securities are specified. In the preferred embodiment, ordinary cash dividends are separated from the remainder of risks and cash flows from an individual stock. There are a large number of other possible permutations. The dividend strip could include dividends paid in stock as well as those paid in cash, for example. The dividend strip could also be for a limited term. For example, it could be all ordinary dividends for 5 years after the date of original issue of the security.

Nothing prevents a similar mechanism from being used to separate voting rights from the underlying shares. Such a mechanism might prove useful to institutional investors who wish to provide others power and discretion in shareholder voting.

At step 205, government filings for the new securities are created. In the U.S. such filings are usually made with the Securities Exchange Commission (SEC). The methods for creating SEC filings are familiar to those skilled in the art of creating initial public offerings or subsequent issuances of additional shares.

At step 207, original shares of stock are purchased for creation of derivative securities 209. The multiple classes of new securities are put on sale to the public 211. New securities include an aftermarket nondividend-paying stock in a single company 213 and an aftermarket equity strip in a single company 215.

It is possible that demand exceeds supply for the new securities 213 and 215. If more shares are needed now 217, a “yes” allows the process to repeat as needed from step 205 government filings. If no more shares are needed now, the process stops or waits for additional demand at a later date 219.

Equity Strips for Multiple Existing Stocks

It is a fallacy that the value of a stock should be the best estimate of the present value of the dividend stream. It is an even greater fallacy that the value of an index, such as the S&P 500 Index, should be the weighted present value of the dividend streams of its components.

Making the assertion that an individual stock should have its value determined by the market's best estimate of its present value of future dividend payments ignores an assortment of other methods by which a shareholder might derive cash income:

Selling the shares on the open market

Stock buybacks by the issuer

Cash acquisition by another company

Merger or acquisition using stock which the shareholder subsequently sells

Going private

Spinoff of subsidiary shares which are subsequently sold

Liquidation in bankruptcy.

In addition to these methods of deriving income, investors in an S&P 500 index fund will find other sources of cash income:

Rebalancing, that is some shares in the fund must be sold to match the revised weighting of the S&P 500, such as selling additional shares or partial share repurchases.

Removal from the index for causes not listed above, such as thin trading, becoming unrepresentative of its industry group, corporate restructuring, or bankruptcy reorganization.

In an average year, 40-60 companies in the S&P 500 will be removed. About half of these are due to mergers and acquisitions where the new company is no longer in the index. Thus, about 2-5% of the value of the index leaves each year and is replaced by other stocks. This is much higher than the typical 1.5% dividend yield seen in the late 1990s. The cash generated at an S&P 500 tracking fund by non-dividend cash flows is typically 2-3 times as large as dividend cash flows.

Dividends as a percentage of the realized gain on investments varies wildly from one year to the next, from 5% to 90% in recent years on the S&P 500. Thus, in recent years ordinary income from dividends has been much smaller than realized income from shares which are sold. Unlike dividends, realized gains could easily go negative in a bear market.

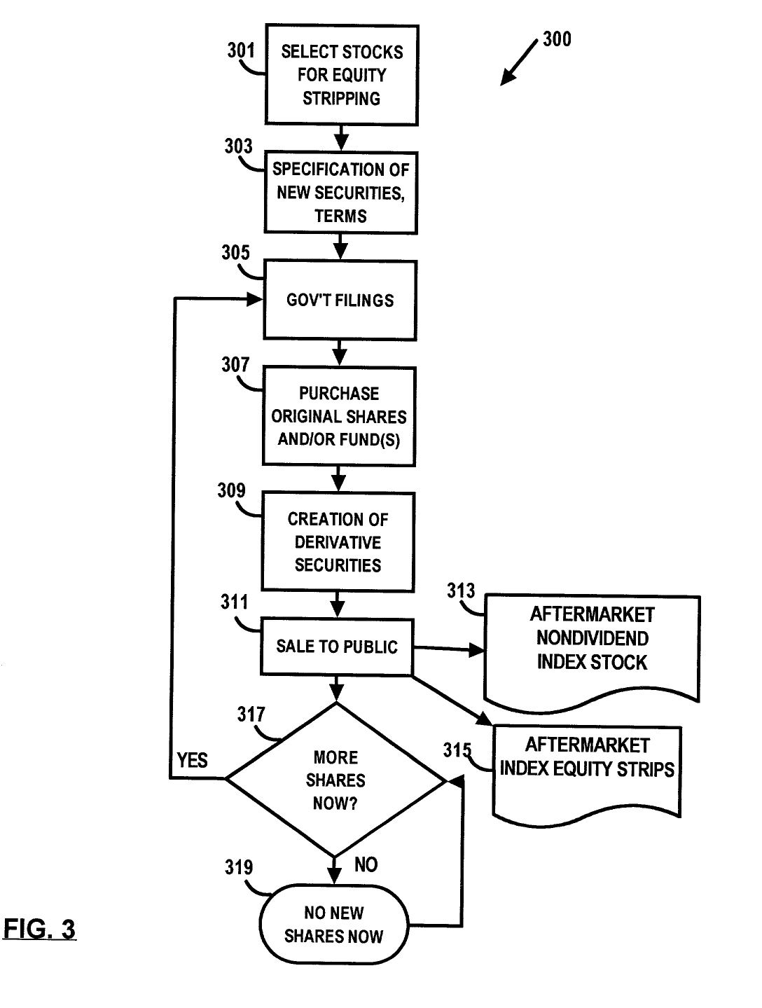

FIG. 3 illustrates steps of an exemplary preferred method 300 for creating equity dividend strips using existing shares of a multiple companies.

At step 301, stocks are selected for equity stripping. There are a large number of possible methods for selecting such stocks. Such methods might include: a request from the an exchange or publisher whose stock index will be stripped (e.g., S&P 500, Dow Industrials); choosing a group of companies with a large number of outstanding shares and a high dividend yield; choosing an industry group, such as banking or utilities; performing surveys or market research among potential investors; financial ratio analysis; choosing companies which currently do not pay dividends, but may do so in the future; choosing companies which are owned by a particular mutual fund; choosing companies which are part of an index stock (such as the NASDAQ index stock QQQ or the S&P 500 index stock SPDR currently traded on the American Exchange) or searching for a group of companies with a high number of dividend checks issued each quarter.

At step 303, the new securities are specified. In the preferred embodiment, ordinary cash dividends are separated from the remainder of risks and cash flows from the stocks. This dividend may also be for a limited term, such as 5 or 10 years. As with individual stocks, there are a number of other possible permutations. With multiple stocks, certain choices are available which are difficult or impossible with a single stock, such as directing income from an equity dividend strip to a particular investment.

At step 305, government filings for the new securities are created. In the U.S. such filings are usually made with the Securities Exchange Commission (SEC).

At step 307, original shares of stocks, index stocks, unit investment trust, mutual finds, or other securities based on common stock are purchased for creation of derivative securities 309. The multiple classes of new securities are put on sale to the public 311. New securities include aftermarket nondividend-paying stock 313 and aftermarket equity strips 315.

It is possible that demand exceeds supply for the new securities 313 and 315. If more shares are needed now 317, a “yes” allows the process to repeat as needed from step 305 government filings. If no more shares are needed now, the process stops or waits for additional demand at a later date 319.

Creation of Equity Dividend Strip Traded Futures and Options

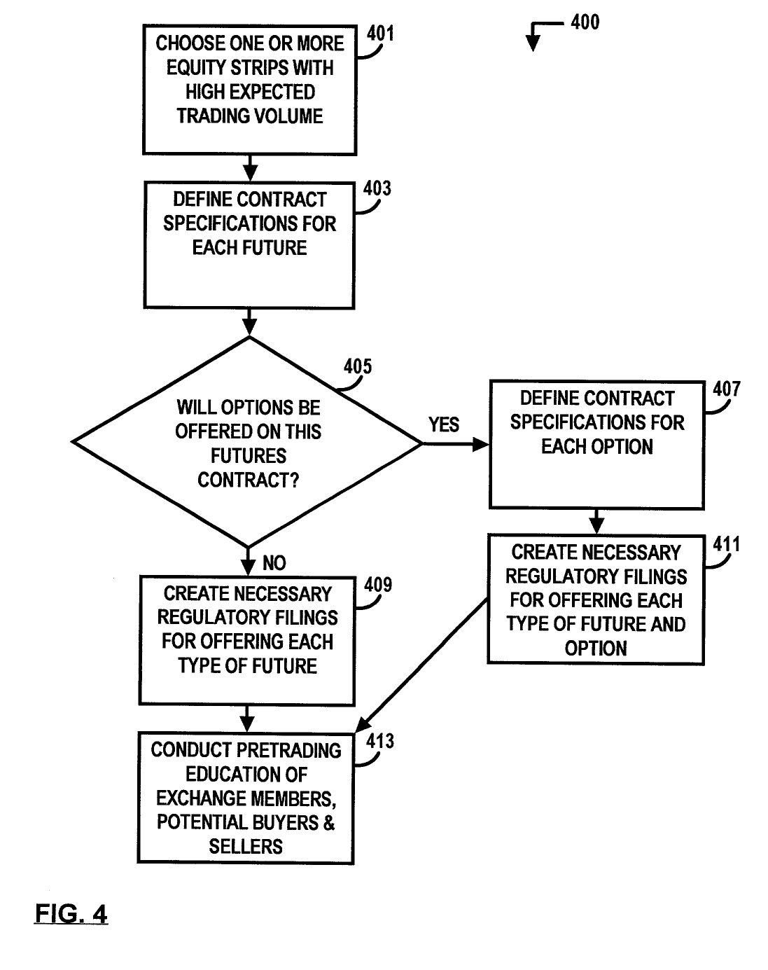

FIG. 4 illustrates steps of an exemplary preferred method 400 for creating equity dividend strip futures and/or options. Futures and options are created with the expectation that at least one party to a futures or option transaction does not own the underlying security.

Though quite common, it is not a requirement that a particular futures or options contract is based on an exchange-traded security, or even any security at all. For example, there is no underlying security or commodity for the Quarterly Bankruptcy Index traded on the Chicago Mercantile Exchange. Similarly, it is possible to create futures and options contracts on a theoretical equity dividend strip even when the underlying equity dividend strip does not exist or is not traded.

Step 401 involves choosing one or more stocks for equity strip futures. It is likely that high expected trading volume will be a consideration. Contract specifications for each future is then determined in step 403.

The same parties then determine which contracts should also have exchange traded options in step 405. When it appears that options are desirable, contract specifications for each option are set in step 407.

Necessary regulatory filing for futures and options are created in steps 409 and 411, respectively. Concurrent to, or subsequent to, regulatory filings, marketing and education for exchange members, brokers, and potential buyers and sellers are preferably provided in step 413.

Issuing Stock with Detachable Dividend Strips

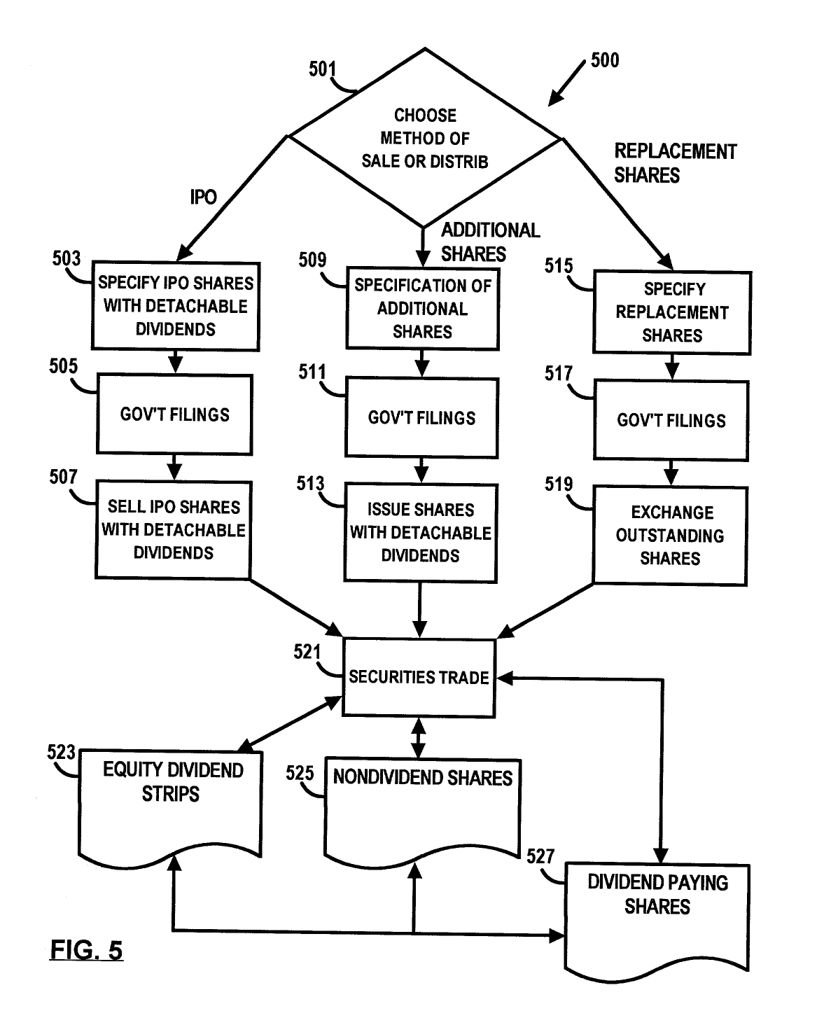

FIG. 5 illustrates an exemplary preferred method 500 for a company to issue its own common stock with a detachable dividend strip. The steps in FIG. 5 can be used virtually unchanged for shares in a single company's own stock, a mutual fund, a unit investment trust, or an index find. In those cases, mutual fund, unit investment trust or index fund can be substituted for company and shares in the mutual fund, unit investment trust or index fund can be substituted for the single company stock.

There are three common circumstances treated in FIG. 5: the company has not yet issued publicly traded stock and will be performing an initial public offering (IPO), the company has outstanding publicly traded stock and will be issuing additional stock, and the company has outstanding publicly traded stock which it will be replacing with new securities.

At step 501, the issuing company reviews its circumstances to choose a method of sale or distribution for the new securities with detachable dividend strips. In some cases, the company will have only one choice, as would often happen with an IPO. In other cases, the company will have two or more viable options, as would often happen for a company which might issue additional stock or replace outstanding stock.

If the company chooses IPO, at step 503 the company creates specifications for IPO stock with detachable dividends. At step 505 necessary government filings are created, such as a prospectus. In most circumstances, there will be a single prospectus even though the securities can be separated. At step 507 the company and its investment bankers or advisors sell the IPO stock with detachable dividends. Steps 503-507 are similar to creation of a traditional initial public offering. With the exception of creating stock with a detachable dividend strip, the process in steps 503-507 should be familiar to those skilled in the art of initial public offerings.

If the company chooses to issue additional stock at step 501, step 509 involves creating specifications for the additional stock. It would often be the case that such stock would be identical to already-issued shares, except that the additional stock would have detachable dividends. If both types of stock traded simultaneously, detachable dividend stock might trade at a premium over older shares, since its owner would have an investment option not available to owners of the older shares which did not have detachable dividends. If two different types of shares were trading simultaneously, the different types would likely require separate listings on one or more exchanges.

Step 511 involves the creation of government filings for the new securities in a manner similar to traditional offerings of additional stock in publicly held companies. Step 513 is the issuance of additional shares with detachable dividends. Steps 509-513 are similar to creation of an initial public offering. With the exception of creating stock with a detachable dividend strip, the process should be familiar to those skilled in the art of issuing additional stock in publicly held companies.

If the company chooses to replace existing shares at step 501, step 515 allows the company to specify the characteristics of the replacement stock. Note that a particular company might issue new shares with detachable dividends and simultaneously replace or exchange outstanding stock with new shares having detachable dividends. This would allow the company to have fewer types of securities trading at once.

Step 517 involves the creation of government filings for the new securities in a manner similar to replacement of stock as the result of a merger or company spinoff. Step 519 involves the exchange of outstanding stock for the new securities.

Regardless of the method by which new securities are sold or created, steps 507, 513, and 519 all lead to securities trading publicly at step 521. At least three different securities can be traded concurrently: single company equity strips 523, consisting of only the ordinary cash dividend payments; nondividend single company stock 525, which does not pay cash dividends; and dividend paying single company stock 527, which behaves much like traditional company stock as long as the dividend strip(s) are not detached.

Equity strips 523, and nondividend company stock 525 can be recombined to create dividend paying stock 527. This process can also be reversed, so that dividend paying stock 527, can be separated into equity strips 523, and nondividend company stock 525. These processes of separation and recombination can occur repeatedly after issuance, usually at the discretion of investors. When separated, an investor has many options. Among these options, he may sell one security and retain the other, sell both securities at different times, hold one security in a retirement account and the other outside of a retirement account, or hold one security and donate another to a charity.

I claim:

1. A method of creating new securities from existing shares of common stock in one or more companies, the method comprising the step of:
creating two new securities from the original common stock, said securities comprising an equity dividend strip and a nondividend paying stock.

2. The method of claim 1 wherein:
the common stock is a single class of stock in a single company.

3. The method of claim 1 wherein:
the common stock is stock from companies comprising a preexisting index.

4. The method of claim 1 wherein:
the common stock is stock from two or more companies.

5. The method of claim 1 wherein:
the common stock is owned indirectly via a mutual fund.

6. The method of claim 1 wherein:
the common stock is owned indirectly via a unit investment trust.

7. The method of claim 1 wherein:
the common stock is owned indirectly via index shares.

8. The method of claim 1 wherein:
the new securities are traded on an exchange.

9. The method of claim 1 wherein:
the new securities are traded over the counter.

10. The method of claim 1 wherein:
the new securities are privately traded.

11. The method of claim 1 wherein:
the same investor holds said equity dividend strips in a different account from said nondividend paying stock.

12. The method of claim 12 wherein:
an investor holds said equity dividend strips in a retirement account and holds said nondividend paying stock outside of a retirement account.

13. The method of claim 12 wherein:
an investor contributes said equity dividend strips to a charity and retains said nondividend paying stock.

14. The method of claim 1 wherein:
said equity dividend strip is for dividends for a limited term.

15. Equity dividend strips comprising:
a security which pays the security's owner an amount calculated in consideration of actual dividends paid by one or more companies, said amount not being calculated in consideration of market value of underlying stock of said one or more companies.

16. The equity dividend strips of claim 15 wherein:
the amount paid to the security's owner is calculated in consideration of actual dividends of one company.

17. The equity dividend strips of claim 15 wherein:
the amount paid to the security's owner is calculated in consideration of actual dividends of two or more companies.

18. The equity dividend strips of claim 15 wherein:
the amount paid to the security's owner is calculated in consideration of actual dividends of companies in a preexisting index.

19. The equity dividend strips of claim 15 wherein:
the amount paid to the security's owner is calculated in consideration of actual dividends of companies in a specified group.

20. Shares with a detachable dividend strip comprising:
a security which allows its owner to separate and transfer ownership of ordinary cash dividend payments.

21. The shares with a detachable dividend strip of claim 20 wherein:
said shares with a detachable dividend strip are issued directly by the company in whom the shares provides ownership.

22. The shares with a detachable dividend strip of claim 20 wherein:
said shares with a detachable dividend strip are not issued directly by the company in whom the shares provides ownership.

23. The shares with a detachable dividend strip of claim 20 wherein:
said shares with a detachable dividend strip are issued by a mutual fund.

24. The shares with a detachable dividend strip of claim 20 wherein:
said shares with a detachable dividend strip are issued by a unit investment trust.

25. Nondividend paying shares comprising:
a security which has the characteristics of common stock except that the security's specification does not provide for allowing payment of ordinary cash dividends to the security's owner.

26. The shares of claim 25 wherein:
said security is issued directly by the company in whom the shares provides ownership.

27. The shares of claim 25 wherein:
said security is not issued directly by the company in whom the shares provides ownership.

28. The shares of claim 25 wherein:
said security is issued by a mutual fund.

29. The shares of claim 25 wherein:
said security is issued by a unit investment trust.

30. Equity dividend strip futures or options comprising:
an exchange traded futures or options contract including terms which are determined in consideration of actual dividend payments on shares of common stock in one or more companies.

31. The equity dividend strip futures or options of claim 30 wherein:
said futures or options contract is based on terms determined in consideration of actual dividend payments of a single company's stock.

32. The equity dividend strip futures or options of claim 30 wherein:
said futures or options contract is based on terms determined in consideration of actual dividend payments of stock of more than one company.

33. The equity dividend strip futures or options of claim 30 wherein:
said futures or options contract is based on terms determined in consideration of actual dividend payments of companies comprising a preexisting index.

34. Combining one or more detachable equity strips and one or more nondividend paying stocks to recreate one or more shares of a security originally issued with a detachable dividend strip.
